(19) United States
(12) Patent Application Publication
(10) Pub. No.: US 2011/0052025 A1
(43) Pub. Date: Mar. 3, 2011

(54) SYSTEM FOR IMAGING PATHWAY VERIFICATION

(75) Inventors: Ralph Highnam, Mount Victoria (NZ); John Michael Brady, Headinton (GB); Nico Karssemeijer, Ubbergen (NL); Martin Yaffe, Toronto (CA)

(73) Assignee: Matakina Technology Limited, Mt. Victoria (NZ)

(21) Appl. No.: 12/848,942

(22) Filed: Aug. 2, 2010

(30) Foreign Application Priority Data
Aug. 3, 2009 (NZ) 578763
Aug. 3, 2009 (NZ) 578764

(51) Int. Cl. G06K 9/00

(52) U.S. Cl. 382/131

(57) ABSTRACT

The disclosure includes computer implemented methods and devices comprising processors for inputting images and medical history into an electronic medium and analyzing x-ray images of a subject's breasts to determine density. The disclosure further contemplates using these methods and devices to generate a numerical value. The disclosure further contemplates using the numerical value to determine whether the subject should have magnetic resonance imaging of the breasts.

### RELATED APPLICATION

This application claims priority to New Zealand Provisional Patent Application No. 578763 filed on Aug. 2, 2009 and New Zealand Provisional Patent Application No. 578764 filed on Aug. 2, 2009, each of which are specifically incorporated by reference in its entirety herein without disclaimer.

### FIELD

The present invention relates to a means for automated retrospective examination of clinical data and images to ensure that the correct pathways have been utilized for patients to prevent compromised care and further that resources have been used efficiently in particular eradicating potential for harm to a recipient.

### BACKGROUND

Worldwide, some 1.1 million women are diagnosed with breast cancer and over 400,000 women will die from it each year. Early detection of malignancies through the use of routine breast cancer screening involving various imaging modalities may provide the best prognosis. Many countries have population based screening programs, whereas others, such as the United States, leave it more to the individuals and local organizations to decide on screening. Despite this, the content and style of screening programs are broadly similar between different western countries.

In breast imaging in the United States, there are some 8,600 imaging centers staffed by some 2,500 specialist mammography radiologists and 15,000 general radiologists who use mammography (x-ray) to screen 43 million women every year with that number growing year-on year with an aging population. However, routine screening detects only around 20% of all diagnosed breast cancers, misses 20% of those cancers that were present at screening, and some 80% of biopsies turn out to be for benign disease. Reader expertise is a factor, but a further difficulty is the lack of tissue differentiation in the image in particular in relation to non-fatty or dense breasts as cancer embedded in the densest tissue is more difficult to see. For example, one issue is the fact that a mammogram is created by sending x-ray photons towards the breast and then detecting how many x-ray photons make it through. Denser breast tissue has a smaller number of x-ray photons that are able to pass through it. FIG. 1.

Breast density has been linked by many studies to likelihood of developing breast cancer and most of those studies have assessed breast density either using visual or semi-automated methods. A general overview is given, for example, in Breast Cancer Research's review series, including Vachon et al, 2007, Martin and Boyd, 2008, and Yaffe, 2008.

MRI and other imaging modalities are becoming increasingly popular additional test to compensate for such propensity for error. The American Cancer Society (ACS) has produced guidelines for breast MRI screening which include the following: 1) women with a breast cancer gene such as BRCA1 or BRCA2; 2) women who are a first degree relative (parent, sibling, or child) of someone with a breast cancer gene; 3) women who have a lifetime risk of 20-25% based on a breast cancer prediction model determined primarily by family history, such as the BRCAPRO model; 4) women who have received radiation to the chest between age 10 and 30 years (such as is given for Hodgkin's Disease); and 5) women who possess various rare syndromes that have a high incidence of breast cancer.

However, There is insufficient evidence to determine if MRI Breast Cancer Screening is useful or not for: 1) women who have a lifetime risk of 15-20% based on a breast cancer prediction model determined primarily by family history, such as the BRCAPRO model; 2) women who have lobular carcinoma in situ (LCIS) or atypical lobular hyperplasia (ALH); 3) women who have atypical ductal hyperplasia (ADH); 4) women who have dense breasts on mammography; 5) women with a personal history of breast cancer, including ductal carcinoma in situ (DCIS). MRI screening is also not recommended for women who have a less than 15% lifetime risk of breast cancer, this group includes the majority of women.

Currently, most health insurers in the United States allow breast MRI scans if reasonable and necessary, and if performed on a United States Food and Drug Administration approved model of MRI equipment. However, these terms are often interpreted differently by various health care providers. Due to the relative inability of detecting malignancies in women with dense breast tissue during routine mammography, dense breast tissue may soon be included into one of the many breast cancer risk models available and as criteria for when doing an MRI is appropriate. The continuing rise of breast MRI and the associated costs involved will inevitably mean stricter conditions under which breast MRI can be performed and yet many of the judgements are subjective, especially around breast composition. Radiologists in the US give each case a BI-RADS composition score (FIG. 2) to provide an estimate for how difficult-to-diagnose a case is but the system has been shown to be unreliable (Martin et al., 2006).

New Zealand Patent Application Nos. 575948 and NZ 578465, which are herein incorporated by reference, have previously detailed systems for working out automatically and objectively breast composition and demonstrated the difficulty of such methods. New Zealand Patent Application No. 578763, which is hereby incorporated by reference, explains methods of using those systems for optimized resource allocation in a forward-looking sense. However, those systems use as inputs raw, or for processing digital mammograms, but recent work disclosed by van Engeland, 2006, demonstrates that the software can also be run, with minor modifications, on “for presentation” digital mammograms, which are the mammograms normally saved by an imaging facility onto a archiving solution and are images which the radiologist will actually have diagnosed from (as compared to the raw data).

### SUMMARY

The methods described herein include computer implemented method comprising inputting a digitized breast x-ray image of a subject into an electronic storage medium; inputting the subject's medical history into the electronic storage medium, analyzing the density of the breast x-ray image; comparing the density of the image to the medical history of the subject; and generating a numerical value.

In certain instances, the electronic storage medium may be an optical drive, a flash drive, a hard drive, a magnetic tape drive, or RAM.

In certain instances, the subject's medical history includes one or more of the following: 1) the subject has a breast cancer gene BRCA1; the subject has a breast cancer gene BRCA2; 2) the subject is a first degree relative (parent, sibling, or child) of someone with a breast cancer gene; 3) the subject has a lifetime breast cancer risk of 20-25% based on a breast cancer prediction model determined primarily by family history; 4) the subject has received radiation to the chest between age 10 and 30 years; and 4) the subject possesses one or more rare syndromes that have a high incidence of breast cancer.

In certain instances, the density of the breast x-ray image involves the use of a Volpara software program. Alternatively or additionally, in certain instances, analyzing the density of the breast x-ray image involves the use of a Cumulus software program.

In certain instances, the numerical value generated is used to determine if the subject should have magnetic resonance imaging performed on breasts of the subject. Optionally, the numerical value generated is used to determine if the subject should have ultrasound performed on breasts of the subject. Optionally, the numerical value generated is used to determine if the subject should have tomosynthesis performed on breasts of the subject

The disclosure also contemplates a device comprising a processor configured to extract a density measurement of a digitized breast x-ray image of a subject from an electronic storage medium; extract a medical history of the subject from an electronic storage medium; compare the density of the digitized x-ray image of the subject to the medical history of the subject; and generate a value.

In certain instances, the density measurement is extracted using Volpara software. Additionally or alternatively, the density measurement is extracted using Cumulus software.

In certain instances, the medical history extracted includes one or more of the following: includes one or more of the following: 1) the subject has a breast cancer gene BRCA1; the subject has a breast cancer gene BRCA2; 2) the subject is a first degree relative (parent, sibling, or child) of someone with a breast cancer gene; 3) the subject has a lifetime breast cancer risk of 20-25% based on a breast cancer prediction model determined primarily by family history; 4) the subject has received radiation to the chest between age 10 and 30 years; and 4) the subject possesses one or more rare syndromes that have a high incidence of breast cancer.

The details of one or more embodiments of the disclosure are set forth in the accompanying drawings and the description below. Other features, objects, and advantages of the disclosure will be apparent from the description and drawings, and from the claims.

### BRIEF DESCRIPTION OF THE DRAWINGS

In order that the manner in which the above recited and other enhancements and objects of the disclosure are obtained, a more particular description of the disclosure briefly described above will be rendered by reference to specific embodiments thereof, which are illustrated, in the appended drawings. Understanding that these drawings depict only typical embodiments of the disclosure and are therefore not to be considered limiting of its scope, the disclosure will be described with additional specificity and detail through the use of the accompanying drawings in which:

FIG. 1 shows a subsection of a mammogram of a dense breast where a cancer is embedded in the densest tissue.

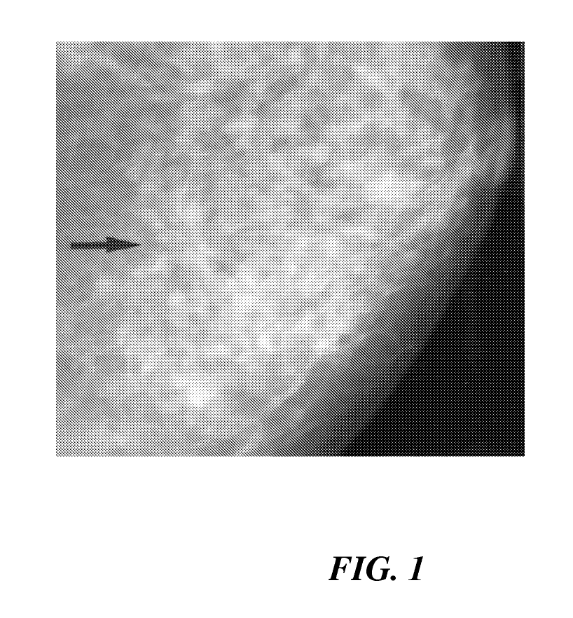

FIG. 2 shows a BI-RADS composition score of breast density

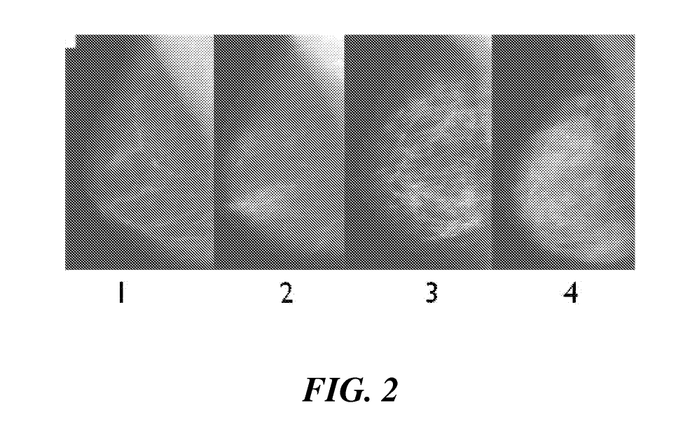

FIG. 3 illustrates a flow chart demonstrating how a radiology benefits management firm (or similar) could run a system inside a hospital which analyzed the patient data including automated breast composition to understand if the patient had, for example, an unnecessary breast MRI.

FIG. 4 illustrates dense breasts and the inner edge targeted by Volpara

FIG. 5 shows Volpara breast density versus that derived from breast MRI.

FIG. 6 shown a relationship between the Cumulus BD % measured on the raw digital (x-axis) and digitized film-screen (y-axis) image.

FIG. 7 shows an association between Volpara™ BD % and BIRADS categories. For each category, the horizontal line shows the median, the box contains the 25th to 75th percentiles of data.

FIG. 8 Association between Cumulus BD % and Volpara™ BD %

FIG. 9 shows an association between Cumulus BD % and absolute Volpara™ dense volume.

FIG. 10 shows Association between Cumulus BD % and absolute Volpara™ dense volume.

### DETAILED DESCRIPTION OF THE DISCLOSURE

### Introduction

The present disclosure relates to a system whereby the information delivered by an automated breast composition software tool is used to analyze x-rays stored in a imaging centre PACS (Picture Archiving and Communication System) for retrospective audit of an imaging facility to understand if the imaging pathways recommend for a particular patient were appropriate. The system automatically interrogates the PACS for related clinical records, such as family history, and then requests the archived image which would be automatically assessed for breast composition; those clinical records and automatically generated breast composition values would then be combined in a novel manner (perhaps using the ACS criteria, or specific criteria laid down by an insurance company) and the system would either decide if the imaging pathway was correctly chosen or pass the whole data set to an expert consultant for review.

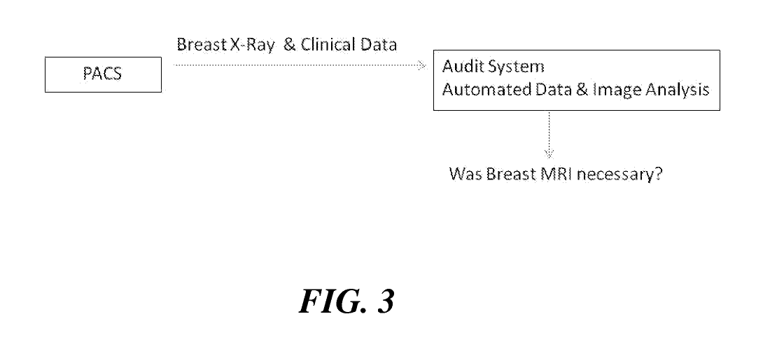

For example, and as illustrated in FIG. 3, a radiology benefits management firm (or similar) could run a system inside a hospital which analysed the patient data including automated breast composition to understand if the patient had, for example, an unnecessary breast MRI. That analysis would be most likely be performed on “for presentation” digital mammograms as the raw data is unlikely to have been stored.

Not only would such a system provide an automated and systematic check on recommend pathways thereby ensuring that poor imaging pathways are highlighted to the relevant clinicians for future patient management improvements, but such a system could introduce labour, time and cost efficiencies.

Many in the field are attempting to quantify images for various purposes but encounter issues relating to errors or unknown values in the imaging physics data. For example, trying to quantify the image based on an absolute model of the physics along with assumed properties of tissue needs all the imaging physics data to be known and accurate.

For example, a mammogram is created by sending x-ray photons towards the breast and then detecting how many x-ray photons make it through. The smaller the number of x-ray photons that make it through, the denser the breast tissue.

Breast density has been linked by many studies to likelihood of developing breast cancer and most of those studies have assessed breast density either using visual or semi-automated methods. A general overview is given, for example, in Breast Cancer Research's review series, including Vachon et al, “Mammographic density, breast cancer risk and risk prediction” (Breast Cancer Research, 2007, vol 9:217), Martin and Boyd, “Potential mechanisms of breast cancer risk associated with mammographic density” (Breast Cancer Research, 2008, Vol 10:201) and Yaffe, “Measurement of mammographic density” (Breast Cancer Research, 2008, Vol 10:209).

### Measuring Breast Density

Area-based breast density measures, both manual and semi-automated, have been repeatedly demonstrated to correlate well with breast cancer risk and with the diagnostic difficulty of a mammogram. (1. Boyd, N., Guo, H., Martin, L., Sun, L., Stone, J., Fishell, E., Jong, R., Hislop, G., Chiarelli, A., Minkin, S., Yaffe, M.: Mammographic density and the risk and detection of breast cancer, New England Journal of Medicine, 356 (3), 2007, p 227-236. 2. Boyd, N., Lockwood, G., Byng, J., Tritchler, D., Yaffe, M.: Mammographic densities and breast cancer risk, Cancer Epidemiol Biomarkers Prey 1998, 7, p 1133-44. 3. Harvey, J., Bovbjerg V.: Quantitative assessment of mammographic breast density: relationships with breast cancer risk. Radiology, 230, 2004, p 29-41. 4. Wolfe, J.: Breast patterns as an index of risk of developing breast cancer, Am J Roentgenol, 1976, 126: p 1130-9 5. Wolfe, J.: Risk for breast cancer development determined by mammographic parenchymal patterns. Cancer, 1976, 37: p 2486-2492. 6. Saftlas, A., Szklo, M.: Mammographic parenchymal patterns and breast cancer risk. Epidemiol Rev 1987, 9: p 146-174 7. Goodwin, P., Boyd N.: Mammographic parenchymal patterns and breast cancer risk: a critical appraisal of the evidence. Am J Epidemiol 1988, 127: p 1097-1108. 8. Carney, P., Miglioretti, D., Yankaskas, B., Kerlikowske, K., Rosenberg, R., Rutter, C., Geller, B., Abraham, L., Taplin, S., Dignan, M., Cutter, G., Ballard-Barbash R: Individual and combined effects of age, breast density, and hormonal replacement therapy use on the accuracy of screening mammography. Ann Intern Med 2003, 138: p 168-75 9. Buist, D., Porter, P., Lehman, C., Taplin, S., White, E.: Factors contributing to mammography failure in women aged 40-49 years. J Nat Cancer Inst 2004, 96: p 1432-40. 10. Saftlas, A., Hoover, R., Brinton, L., Szlo, M., Olson, D., Salane, M., Wolfe, J. Mammographic densities and risk of breast cancer. Cancer 1991, 67: p 2833-2838. 11. Wolfe, J., Saftlas, A., Salane, M.: Mammographic parenchymal patterns and quantitative evaluation of mammographic densities: a case-control study. Am J Roentgenol 1987, 148: p 1087-1092.). These types of measures are increasingly suggested as a basis for tailoring breast screening for each individual woman. However, such area-based measures are increasingly subjective, and there is a substantial inter- and intra-observer variability (12. American College of Radiology, Breast imaging reporting and data systems (BIRADS). Reston, Va.: American College of Radiology, 1993, 13. Martin et al, Mammographic density measured with quantitative computer-aided method: comparison with radiologists' estimates and BI-RADS categories, Radiology, 240 (3), 2006, p 656, 14. Nicholson, B., LoRusso, A., Smolkin, M., Bovbjerg, V., Petroni, G., Harvey, J.: Accuracy of assigned BIRADS breast density category definitions, Academic Radiology, Volume 13, Issue 9, Page 1143-1149.). Additionally, these methods require additional decision-time by skilled users. The result is that although the results generated by trained users in research environments are encouraging, the applicability of such methods in the real-world is at best problematic. Unfortunately, to date, the automation of areas based density measures, to the point where they can be incorporated into clinical workflow have proven difficult, primarily due to differences in imaging parameters, making the image brighter or darker or affecting the contrast with the result appearing more or less dense, and to textural similarities between very fatty and very dense breasts.

Volumetric breast density measurements, which are, in principle, objective and straightforward to automate, have been proposed based upon a succession of physics based models of the x-ray imaging process [15. Diffey, J., Hufton, A., Astley, S.: A new step-wedge for volumetric measurement of mammographic density. International Workshop on Digital Mammography 2006, Lecture Notes in Computer Science, 4046, Springer Berlin/Heidelberg. 16. van Engeland, S., Snoeren, P., Huisman, H., Boetes, C., Karssemeijer, N.: Volumetric breast density estimation from full-field digital mammograms, IEEE Medical Imaging, 25 (3), March 2006, p 273-282, 17. Highnam, R., Brady, M.: Mammographic Image Analysis, Kluwer Academic, 1999. 18. Shepherd, J.: Automated volumetric density, 3rd International Workshop on Breast Density, 2008. 19. Tromans, C., Brady, M., Van de Sompel, D., Lorenzon, M., Bazzocchi, M., Zuiani, C.: Progress toward a quantitative scale for describing radiodensity in mammographic images, International Workshop on Digital Mammography 2008, Lecture Notes in Computer Science, 5116, Springer Berlin/Heidelberg. 20. Pawluczyk, O., Yaffe, M., Boyd, N., Jong, R.: Volumetric method for estimation of breast density on digitized screen-film mammograms, Medical Physics, 30(3), p352, 2003.]. They have been shown to compare well to visual estimations of breast density. However, to date, the correlation to breast cancer risk has been variable [21. McCormack, V., Highnam, R., Perry, N., dos Santos Silva, I: Comparison of a new and existing method of mammographic density measurement, Cancer, Epidemiol Biomarkers Prev 2007, 16(16), p 1148-54.]. This may be due primarily to current volumetric models overly relying on imaging physics data that is assumed to be accurate. Therefore it may be advantageous to develop a “relative” (as opposed to absolute) physics model which can reduce the need for accurate imaging physics data by optimizing the information extracted from the image itself.

Cumulus [Byng, J. W., Boyd, N. F., Fishell, E., Jong, R. A., Yaffe, M. J.: The quantitative analysis of mammographic densities. Phys Med Biol. 39, 1629-38 (1994)] and similar mammographic density estimator programs are widely considered to be the gold standard for breast density work. They are based on a user defined thresholding method, and the density calculation is area-based, i.e. calculated from the area of the projected image. These measures have been shown in a metaanalysis to correlate well with breast cancer risk [McCormack, V., dos Santos Silva, I.: Breast density and parenchymal patterns as markers of breast cancer risk: a meta-analysis. Cancer Epidemiol Biomarkers Prey. 15, 1159-69 (2006)]. Nonetheless, the method is subjective and the density measures that results from its use are highly dependent on the observer, with substantial inter- and intra-observer variability, although training does appear to reduce this variability [Prevrhal, S., Shepherd, J., Smith-Bindman, R., Cummings, S., Kerlikowske, K.: Accuracy of Mammographic Breast Density Analysis: Results of Formal Operator Training. Cancer Epidemiol Biomarkers Prey. 11, 1389-93 (2002), Martin, K. E., Helvie, M. A., Zhou, C., Roubidoux, M. A., Bailey, J. E., Paramagul, C., Blane, C. E., Klein, K. A., Sonnad, S. S., Chan, H. P.: Mammographic density measured with quantitative computer-aided method: comparison with radiologists' estimates and BI-RADS categories. Radiology. 240, 656-65 (2006)].

Other solutions to the quantification of breast tissue entails insertion of a step wedge in each image. For example: Diffey 2006 “New step wedge for volumetric measurement of density” (IWDM 2006), Augustine 2006 “Volumetric breast density estimation” (IWDM 2006), Patel 2006 “Automated breast tissue measurement of women” (IWDM 2006) and Shepherd 2005 “Novel use of single x-ray absorptiometry for measuring breast density” (Technology in Cancer Research & Treatment, 2005, Vol 4: 173-182).

Alternative approaches known in the field include: the use of simple physics to split the breast into density classes, although such method does not appear to use in-image reference data (Merelmeier 2007 “Displaying an x-ray image recorded on mammography,” WO/2008/052854); simple tissue density method not using any image calibration (Tasaki 2007 “Imaging system,” WO/2008/038525); tissue density via a scout x-ray exposure (Jing 2003 “Mammography with tissue exposure control, Tomosynthesis,” WO/2004/049949); use of a grid on top of a compression plate to find breast thickness (Yang 2003 “Measuring the thickness of compressed objects” WO/2004/000121); use of phantom images to work out the breast edge thickness (Rico 2003 “Determining peripheral breast thickness” WO/2004/000110); use of a physical grid for a manual assessment of density (Bershtejn 2008 “Adipose tissue percentage evaluation in mammary gland” RU2325852); use of density for prognosis purposes (Giger 2003 “Computerised image analysis prognosis” US2004101181); use of density image for reconstruction purposes (Clause 2008 “Quantitative image reconstruction method” US20080292217); film work covering film-curve approximations (Highnam 2000 “X-ray image processing” WO/2000/052641); use of the pectoral muscle to normalize the data (Kotsuma 2008 “Quantitative assessment of mammographic density and breast cancer risk for Japanese women” Breast, 2008); and improved semi-automated threshold technique (Byng 1994 “Quantitative analysis of mammographic densities”, Physics in Medicine & Biology, 1994); use of dual energy as per bone density (Shepherd 2002 “Measurement of breast density with dual x-ray absorptiometry: feasibility” Radiology 2002); computation of density from MRI (Klife 2004 “Quantification of breast tissue index from MR data using fuzzy clustering”, IEEE Engineering in Medicine & Biology Society, 2004); and computation of density from ultrasound (Glide 2007 “Novel approach to evaluating breast density utilizing ultrasound tomography” Medical Physics, 2007).

There is increasing interest in the potential for fully automated volumetric measures of breast density. The advantages of these methods include an elimination of user variability, elimination of the time-consuming density estimation and consideration of the breast as a 3-D organ. One user-independent, volumetric breast density method, known as Volpara™, can be compared to a visual assessment and to a previous method known as Cumulus. Volpara™ is based around a relative physics model, and is an extension of work described previously [Jeffreys, M., Warren, R., Highnam, R., Davey Smith, G.: Initial experiences of using an automated volumetric measure of breast density: the standard mammogram form. Br J. Radiol. 79, 378-82 (2006); Aitken, Z., McCormack, V. A., Highnam, R. P., Martin, L., Gunasekara, A., Melnichouk, O., Mawdsley, G., Peressotti, C., Yaffe, M., Boyd, N. F., dos, S. S., I: Screen-film mammographic density and breast cancer risk: a comparison of the volumetric standard mammogram form and the interactive threshold measurement methods. Cancer Epidemiol Biomarkers Prey. 19, 418-28 (2010)]. The model was designed from the outset with a focus on temporal comparison and for working on images from all digital detectors. A full description can be found in [R Highnam, M Brady, M Yaffe, N Karssemeijer & J Harvey: Robust Breast Composition Measurements—Volpara, IWDM 2010 (in press)] Key differences with SMF are in the robustness and reliability of the results, especially in dense breasts, and not including skin in the volume of dense tissue.

### EXAMPLES

### Example 1

Previously reported volumetric techniques use some form of calibration object or find a position in the breast image that corresponds to a column of tissue that is entirely fat, give or take a thin layer of skin. Of course, the use of calibration objects should, in principle, lead to highly accurate modeling, and should perhaps be the basis for a research-based “gold standard”. However, the use of such methods within a clinical environment for routine clinical use poses a number of practical challenges such as the need on numerous occasions to remove the calibration object, for example when imaging large breasts. For this reason, we have focused our efforts on finding an area of the breast that corresponds to entirely fatty tissue, then using that as a reference level (P_{FAT}) to find the thickness of dense tissue (h_{d}) at each pixel (x,y) as shown by the following equation from [van Engeland, S., Snoeren, P., Huisman, H., Boetes, C., Karssemeijer, N.: Volumetric breast density estimation from full-field digital mammograms, IEEE Medical Imaging, 25 (3), March 2006, p 273-282] where it is simply assumed that the pixel value (P) is linearly related to the energy imparted to the x-ray detector (all direct digital images match this criteria):

h_{d}(x,y)=ln(P(x,y)/P_{FAT})μ_{fat}-μ_{dense} (equation 1)

The values in the denominator are the effective x-ray linear attenuation coefficients for fat and dense tissue at the particular target, filter, tube voltage and recorded breast thickness combination. This formulation is intrinsically robust to errors in time of exposure, detector gain and other multiplicative variations, since those values appear both in the reference level and in the actual pixel values, so cancel out.

Of course, the difficulty, as pointed out by [Highnam, R., Brady, M.: Mammographic Image Analysis, Kluwer Academic, 1999., McCormack, V., Highnam, R., Perry, N., dos Santos Silva, I: Comparison of a new and existing method of mammographic density measurement, Cancer, Epidemiol Biomarkers Prey 2007, 16(16), p 1148-54.], lies in finding an area of the breast which is entirely fat, especially when the breast in question is very dense (which is the category of highest risk and thus of greatest interest). This issue was overcome while retaining a relative physics model approach by (i) using phase congruency [Kovesi, P.: Image Features from Phase Congruency, Videre, 1999, MIT Press.], which is invariant to imaging conditions, and (ii) an iterative approach to finding the fatty, uncompressed breast edge as documented in [Highnam, R., Brady, M.: Mammographic Image Analysis, Kluwer Academic, 1999.] along with realistic, relative, breast edge models [van Engeland, S., Snoeren, P., Huisman, H., Boetes, C., Karssemeijer, N.: Volumetric breast density estimation from full-field digital mammograms, IEEE Medical Imaging, 25 (3), March 2006, p 273-282, Highnam, R., Brady, M.: Mammographic Image Analysis, Kluwer Academic, 1999.]. PFAT can be determined by finding an accurate breast edge.

A scatter removal process was included based around the algorithm reported in [Highnam, R., Brady, M.: Mammographic Image Analysis, Kluwer Academic, 1999] but adjusted it to again make it work in a relative manner by making simplifications around the variations in scatter-to-primary due to different breast tissue types.

Compression plate slant was corrected by assuming a fixed slant [Highnam, R., Brady, M.: Mammographic Image Analysis, Kluwer Academic, 1999], an assumption which appears valid for most x-ray systems but not for those systems which purposely have a slanted top compression paddle.

The volume of dense tissue is found by integration of the h_{d}(x,y) values over the image, while the volume of the breast is determined by multiplying the area of the breast by the recorded breast thickness; the breast density is then the ratio of the two.

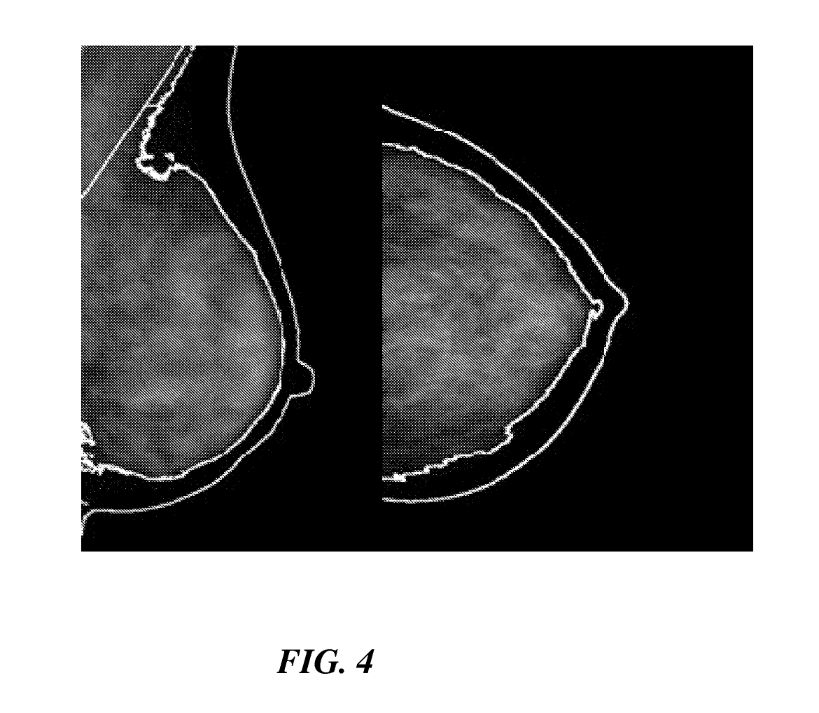

In order to determine accuracy of the methods described above, 2,217 GE digital mammograms were collected from Oslo, Nijmegen and the University of Virginia, and a range of phantoms were imaged in order to validate the Volpara™ software. The results presented in this paper are for version 1.2.1 of that software. The performance the breast edge detection algorithm, and thus the robustness of finding PFAT on very dense breasts can be illustrated by visualization of the inner and outer limits of the uncompressed, fatty breast edge within which PFAT is searched as shown in FIG. 4. The inner limit of the determined breast edge does not overlay any dense tissue.

To demonstrate that Volpara™ is indeed measuring breast density, a set of 5 images of a test phantom acquired with different imaging combinations was analyzed. Each image had 5 “plugs” inserted (labeled A-E below) with different densities and the average error between actual and estimated densities is 1.11%. See Table 1.

TABLE 1
Phantom Data

| | | | | | |
|---|---|---|---|---|---|
| A | B | C | D | E | Imaging Factors |

Toronto Plug Phantoms Actual Plug Densities

| | | | | | | |
|---|---|---|---|---|---|---|
| #1 | 0.0 | 25.0 | 25.0 | 12.5 | 25.0 | MoMo26 76mAs |
| #2 | 0.0 | 25.0 | 25.0 | 12.5 | 25.0 | MoMo28 51mAs |
| #3 | 0.0 | 20.0 | 20.0 | 10.0 | 20.0 | MoMo26 110mAs |
| #4 | 0.0 | 16.7 | 16.7 | 8.3 | 16.7 | MoRh26 155mAs |
| #5 | 12.5 | 37.5 | 37.5 | 25.0 | 37.5 | MoMo28 55mAs |

Volpara V1.2.1 Estimated Plug Densities

| | | | | | |
|---|---|---|---|---|---|
| #1 | 0.43 | 23.9 | 24.3 | 9.9 | 23.0 |
| #2 | 0.16 | 23.8 | 24.0 | 9.7 | 22.9 |
| #3 | 0.41 | 20.1 | 20.2 | 8.6 | 18.0 |
| #4 | 0.64 | 17.8 | 18.0 | 7.8 | 15.8 |
| #5 | 13.6 | 39.2 | 39.2 | 25.2 | 37.6 |

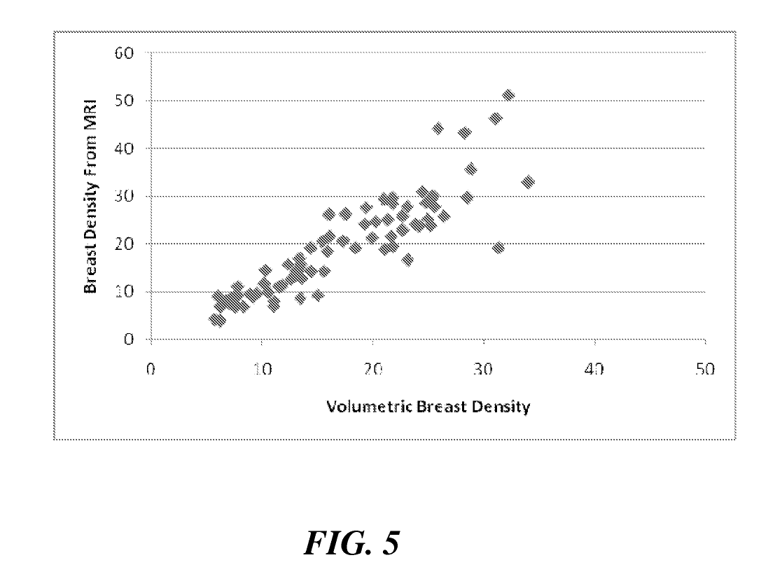

Further, fibroglandular volume was manually measured. Breast density from breast MRI volumes for 26 younger women and found a correlation of 0.94 with the Volpara™ fibroglandular volume, and a close relationship between the breast densities as shown in FIG. 5, the breast densities are offset due to the difficulty of measuring total breast volume in the MRI images [van Engeland, S., Snoeren, P., Huisman, H., Boetes, C., Karssemeijer, N.: Volumetric breast density estimation from full-field digital mammograms, IEEE Medical Imaging, 25 (3), March 2006, p 273-282].

The results were analyzed over the different detectors in the database; Table 2 shows the median breast density for each detector, along with the Pearson Correlation Coefficient for L/R and CC/MLO along with numbers of images. This demonstrates that consistent results were achieved across detectors. An exception is the PM34_{—}05 detector; but that is the detector on which was stored the images of young women who have been imaged prior to having breast MRI, thus the high breast density.

TABLE 2
Comparisons across detectors

| | Median | PCC L/R | PCC CC/MLO | #Images |
|---|---|---|---|---|
| All | 8.8 | 0.923 | 0.915 | 2217 |
| PM54_01 | 8.9 | 0.930 | 0.908 | 937 |
| PM460_2 | 7.8 | 0.914 | 0.878 | 290 |
| PM34_05 | 16.1 | 0.915 | 0.931 | 104 |
| PM079_04 | 8.0 | 0.911 | 0.916 | 881 |

Next, to investigate the robustness of the results to imaging conditions, we edited the mAs in an image (Mo/Mo, 29 kVp) by +/−20% and then again ran Volpara™, as shown in Table 3. As that Table shows, and as expected from Equation (1), identical results were found which were also obtained when multiplying the pixel values in the image by various factors to simulate variations in detector gain.

TABLE 3
Effect of errors in mAs on Volpara's Composition Estimates

| | −20% | 0% | +20% |
|---|---|---|---|
| | (80 mAs) | (100 mAs) | (120 mAs) |
| Volume of Dense Tissue | 114 cm³ | 114 cm³ | 114 cm³ |
| Volume of Breast | 575 cm³ | 575 cm³ | 575 cm³ |
| Breast Density | 19.8% | 19.8% | 19.8% |

For a further demonstration, extra noise was introduced into a set of images by randomly adding or subtracting up to 5% and 10% of the pixel value. The results indicated that noise has limited effect apart from at low breast density. See Table 4.

TABLE 4
Effect of varying level of random noise on
the density estimate by Volpara ™
Volpara 1.2.1 Breast Density Results Running On:

| | Original Image ± | Original Image ± |
|---|---|---|
| Original Image | 5% Random Noise | 10% Random Noise |
| 2.3% | 3.4% | 5.1% |
| 12.4% | 12.5% | 13.5% |
| 19.6% | 19.7% | 17.1% |
| 28.1% | 28.2% | 28.2% |

As noted earlier, breast thickness's major influence is in the breast volume but it is also present to a lesser degree in the dense tissue volume as the effective energy is determined. Whereas previous implementations [Highnam, R., Brady, M.: Mammographic Image Analysis, Kluwer Academic, 1999] had seen these two factors act in different ways so as to amplify the errors; Volpara™'s implementation has the factors acting in the same way. Therefore, if breast thickness rises, then both breast volume rises and the volume of dense tissue rises so that the overall ratio does not vary widely. Table 5 shows the results from Volpara™ over four different images when the breast thickness was varied by 20% up and down. Breast thickness errors will inevitably introduce small errors into the breast density measurement, but due to quality requirements in the field, they should rarely exceed 10% and resulting estimate of breast density remains accurate. Furthermore, because breast thickness is almost always underestimated by the x-ray machine, the woman's density assessment will rise, not lower and thus the woman will never be treated in a lower density and thus risk category.

TABLE 5
Effect of errors in breast thickness on the density estimate by Volpara ™

| | Variation in Breast Thickness (H) | | | | |
|---|---|---|---|---|---|
| H mm | −20% | −10% | 0% | +10% | +20% |
| 86 | 2.5% | 2.4% | 2.3% | 2.2% | 2.1% |
| 32 | 15.1% | 13.6% | 12.4% | 11.4% | 10.6% |
| 20 | 23.7% | 21.4% | 19.6% | 18.0% | 16.8% |
| 40 | 33.6% | 30.5% | 28.1% | 26.2% | 24.4% |

The use of relative physics models throughout our new software has produced a robust breast composition measurement tool, Volpara™ and this has uses for a wide range of clinical work, including tailoring screening, but also for temporal comparison of images. Entirely reasonably and realistically, given the quality regulations that apply to mammography, the algorithm still requires relatively accurate information on kV, target, filter and compressed breast thickness. Inevitably small errors will be present which will have an effect on breast density. Quality control and simple practical measures can be implemented to alert the user as to when their x-ray system or compression paddle needs recalibration.

### Example 2

As part of the American College of Radiology Imaging Network (ACRIN) Digital Mammography (DMIST) trial [Pisano, E., Gatsonis, C., Yaffe, M., Hendrick, R., Tosteson, A., Fryback, D., Bassett, L., Baum, J., Conant, E., Jong, R., Rebner, M., D'Orsi, C.: American College of Radiology Imaging Network digital mammographic imaging screening trial: objectives and methodology. Radiology. 236, 404-12 (2005)], the University of Virginia recruited approximately 1,300 women, most of whom had both a film-screen mammogram and a GE digital mammogram on the same day performed by the same technologist. Cumulus density estimation was performed by one radiologist (JAH) on the left CC image of the digitized film-screen images, and on the “for processing” (i.e. raw) digital image. The BI-RADS breast composition visual assessment (1 to 4) was also performed. From that dataset, the first 105 cases were selected from each of the BIRADS breast composition categories to investigate the performance of Volpara™, a new volumetric breast density method. Statistical methods used were the correlation coefficient, regression coefficient and Bland-Altman analyses for agreement. 95% confidence intervals (CI) were calculated for each estimation.

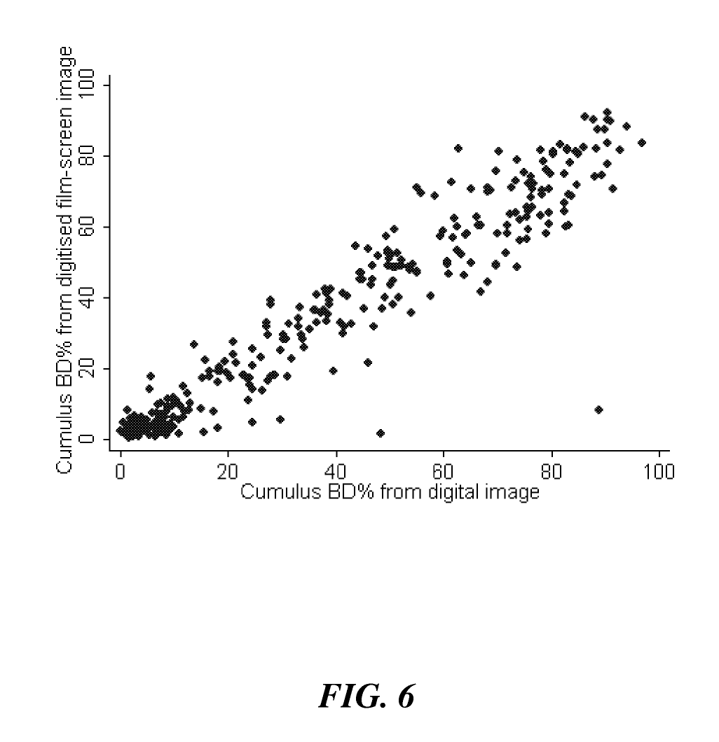

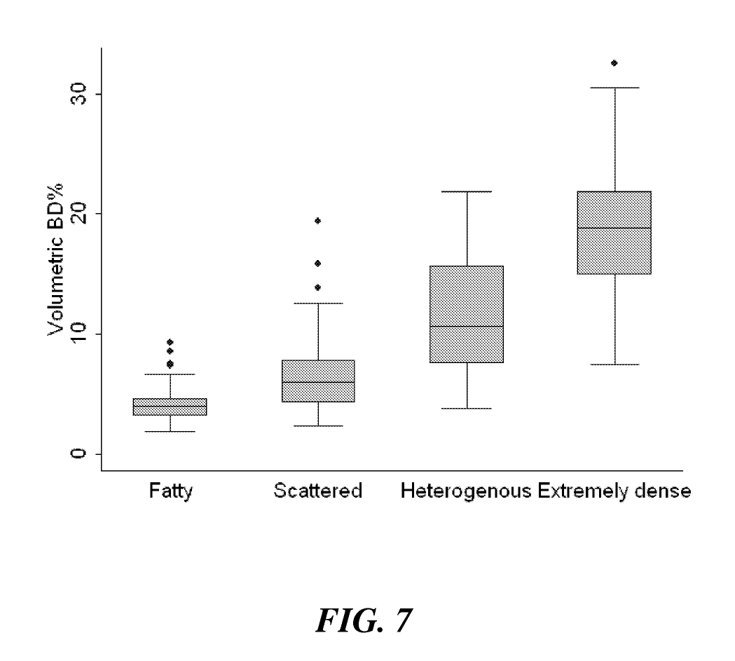

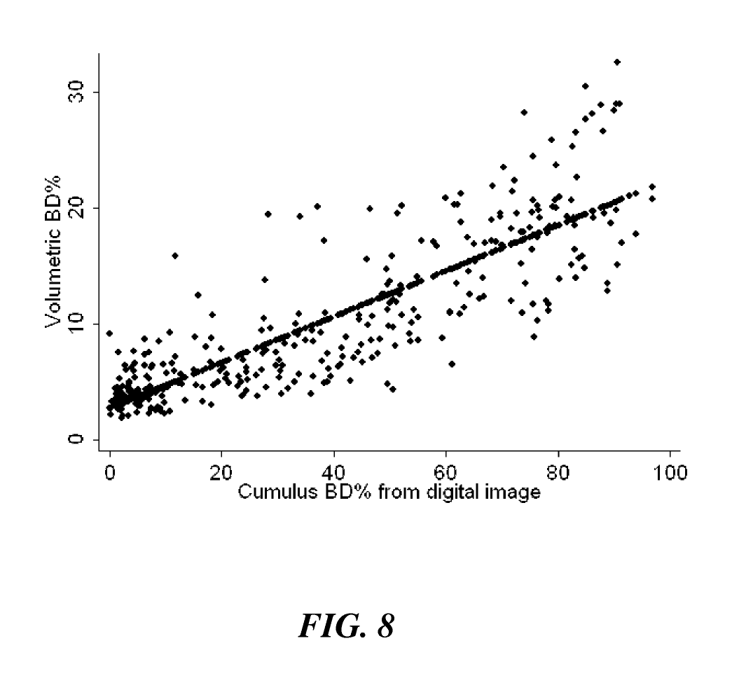

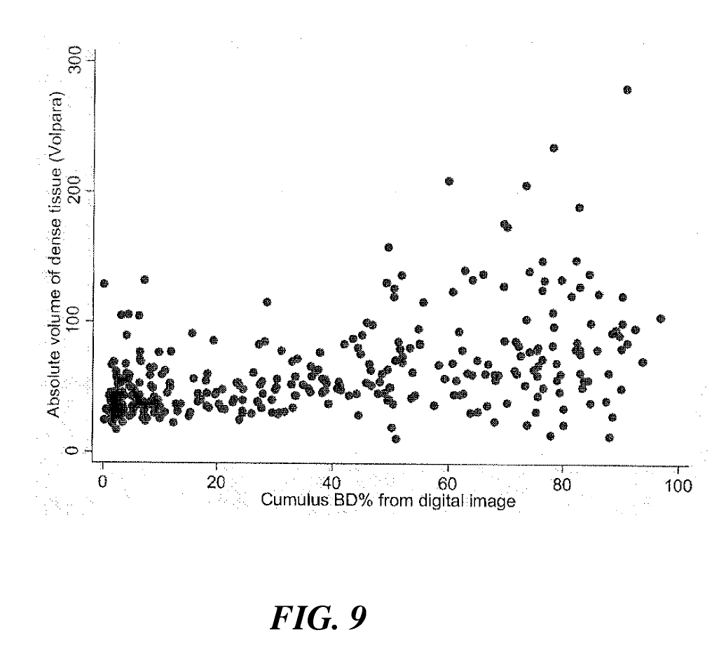

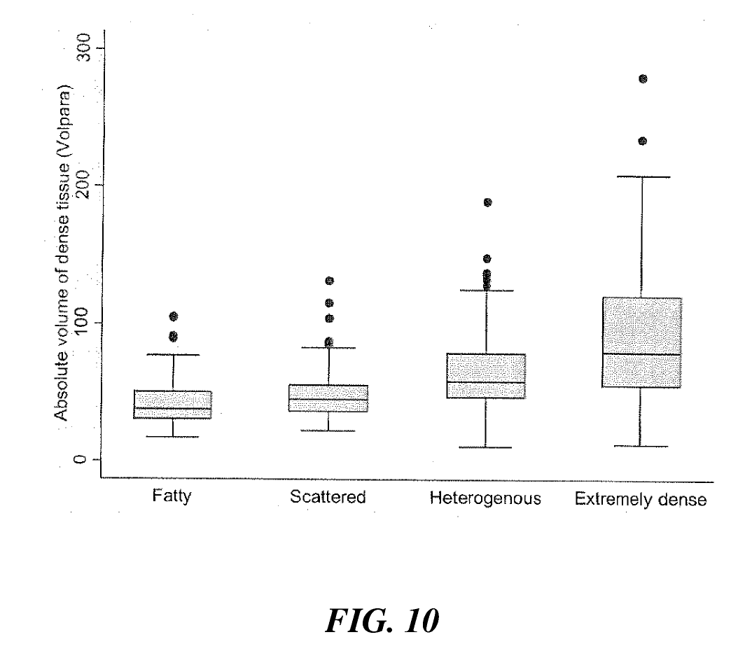

Out of the 420 cases selected, only 324 cases had readings available for both film screen mammograms and digital mammograms. The BI-RADS density was fatty in 82 patients, scattered in 68 patients, heterogeneous in 102 patients, and extremely dense in 72 patients. Cumulus breast density percentage (BD %) from the raw digital image and from the films were closely related to each other, FIG. 6; the correlation coefficient was 0.95. However, the results from the raw digital image were systematically over-estimated compared to from the digitised film (regression coefficient 0.89, 95% CI 0.86 to 0.92, i.e. a 1% increase in the digital image was associated with a 0.89% increase in the analogue image). Using a Bland-Altman analysis to measure agreement, the mean difference between the two measures was −3.96% (95% CI −4.93 to −2.99). There was a strong relationship between Volpara™ BD % and BI-RADS categories, with the median Volpara™ score rising linearly from 4.0% in the lowest BI-RADS category to 18.9% in the top category (FIG. 7). There was also a strong relationship between Volpara™ BD % and Cumulus BD %. The correlation coefficient was 0.85. However, as can be seen from a comparison of the scales of the x and y axes in FIG. 8, the proportion of the breast that is considered dense is much smaller when measured on a volumetric compared to an areal scale. This explains the rather low regression coefficient; a 1% increase in BD % is associated with an 0.20% increase in Volpara™ BD %, 95% CI 0.18% to 0.21%). The relationship between the area-based percentage breast density measures and absolute volume of dense tissue was, as expected, weaker than with the volumetric percent density. The correlation coefficient between the absolute volume of dense tissue and the Cumulus BD % was 0.45, see FIG. 9. A 1% increase in Cumulus BD % was associated with a 0.56 cm3 increase in absolute volume of dense tissue (95% CI: 0.44 to 0.68). There was a small increase in the absolute dense tissue volume across BI-RADS and Cumulus categories, with the median Volpara™ volume rising from 38 cm3 in the lowest BI-RADS category to 80 cm3 in the highest, and from 41 cm3 in the lowest Cumulus category (<10%) to 80 cm3 in the highest (>75%), see FIG. 10.

This is believed to be the first analysis to compare measures of breast density from digitized film-screen and digital images taken on the same day. The analysis demonstrated that BD % from the raw digital image was systematically higher than from the digitized film. A previous analysis suggested the opposite association [Harvey, J. A.: Quantitative assessment of percent breast density: analog versus digital acquisition. Technol Cancer Res Treat. 3, 611-6 (2004)], with a higher mean density when estimated from analogue compared to digital films. However, because the current study was based on films taken on the same day, it is likely that these results are more reliable. As increasingly more studies of breast density are based on FFDM images, these results have implications for the comparisons of studies of breast density using digital or digitized measures.

Volpara™, the new volumetric method of assessing breast density, is designed to be run on FFDM images, and is closely related to breast density from area-based visual techniques (BI-RADS) and a semi-automated technique, Cumulus. There appears to be only a weak linear relationship between the volume of dense tissue and the area based density measure, as has been found with previous comparisons between volumetric and area-based measures [Jeffreys, M., Warren, R., Highnam, R., Davey Smith, G.: Initial experiences of using an automated volumetric measure of breast density: the standard mammogram form. Br J Radiol. 79, 378-82 (2006)].

The range of percent breast density is considerably smaller on the Volpara™ compared to the Cumulus scale. The results are not fully consistent with previously reported measures of volumetric breast density. For example, among women without breast cancer, the inter-quartile range of absolute breast volume when measured by SMF v2.2β run on digitized images was 20.8% to 33.5% [Aitken, Z., McCormack, V. A., Highnam, R. P., Martin, L., Gunasekara, A., Melnichouk, O., Mawdsley, G., Peressotti, C., Yaffe, M., Boyd, N. F., dos, S. S., I: Screen-film mammographic density and breast cancer risk: a comparison of the volumetric standard mammogram form and the interactive threshold measurement methods. Cancer Epidemiol Biomarkers Prey. 19, 418-28 (2010)], compared to 4.6% to 15.6% in this study; this is explained by Volpara™ not including skin in its calculation.

In conclusion, since Volpara™ correlates well with the gold standard measure of breast density, we expect that there should also be a strong relationship between Volpara™ and breast cancer risk. The results presented here support further detailed analysis of the potential of this novel measure in relation to breast cancer outcomes. The most useful study design for this will be a case-control analysis.

### REFERENCES

The following references, to the extent that they provide exemplary procedural or other details supplementary to those set forth herein, are specifically incorporated herein by reference.
New Zealand Patent Application No. 578465
New Zealand Patent Application No. 578763
New Zealand Patent Application No. 575948
American College of Radiology, Breast imaging reporting and data systems (BIRADS). Reston, Va.: American College of Radiology, 1993
Aitken, Z., McCormack, V. A., Highnam, R. P., Martin, L., Gunasekara, A., Melnichouk, O., Mawdsley, G., Peressotti, C., Yaffe, M., Boyd, N. F., dos, S. S., I: Screen-film mammographic density and breast cancer risk: a comparison of the volumetric standard mammogram form and the interactive threshold measurement methods. Cancer Epidemiol Biomarkers Prey. 19, 418-28 (2010)
Boyd, N., Guo, H., Martin, L., Sun, L., Stone, J., Fishell, E., Jong, R., Hislop, G., Chiarelli, A., Minkin, S., Yaffe, M.: Mammographic density and the risk and detection of breast cancer, New England Journal of Medicine, 356 (3), 2007, p 227-236
Boyd, N., Lockwood, G., Byng, J., Tritchler, D., Yaffe, M.: Mammographic densities and breast cancer risk, Cancer Epidemiol Biomarkers Prey 1998, 7, p 1133-44
Buist, D., Porter, P., Lehman, C., Taplin, S., White, E.: Factors contributing to mammography failure in women aged 40-49 years. J Nat Cancer Inst 2004, 96: p 1432-40
Byng, J. W., Boyd, N. F., Fishell, E., Jong, R. A., Yaffe, M. J.: The quantitative analysis of mammographic densities. Phys Med Biol. 39, 1629-38 (1994)
McCormack, V., dos Santos Silva, I.: Breast density and parenchymal patterns as markers of breast cancer risk: a meta-analysis. Cancer Epidemiol Biomarkers Prev. 15, 1159-69 (2006)
Carney, P., Miglioretti, D., Yankaskas, B., Kerlikowske, K., Rosenberg, R., Rutter, C., Geller, B., Abraham, L., Taplin, S., Dignan, M., Cutter, G., Ballard-Barbash R: Individual and combined effects of age, breast density, and hormonal replacement therapy use on the accuracy of screening mammography. Ann Intern Med 2003, 138: p 168-75
Diffey, J., Hufton, A., Astley, S.: A new step-wedge for volumetric measurement of mammographic density. International Workshop on Digital Mammography 2006, Lecture Notes in Computer Science, 4046, Springer Berlin/Heidelberg
Goodwin, P., Boyd N.: Mammographic parenchymal patterns and breast cancer risk: a critical appraisal of the evidence. Am J Epidemiol 1988, 127: p 1097-1108
Harvey, J., Bovbjerg V.: Quantitative assessment of mammographic breast density: relationships with breast cancer risk. Radiology, 230, 2004, p 29-41
Harvey, J. A.: Quantitative assessment of percent breast density: analog versus digital acquisition. Technol Cancer Res Treat. 3, 611-6 (2004)
Highnam, R., Brady, M.: Mammographic Image Analysis, Kluwer Academic, 1999.
Highnam, M Brady, M Yaffe, N Karssemeijer & J Harvey: Robust Breast Composition Measurements—Volpara, IWDM 2010 (in press)
Jeffreys, M., Warren, R., Highnam, R., Davey Smith, G.: Initial experiences of using an automated volumetric measure of breast density: the standard mammogram form. Br J. Radiol. 79, 378-82 (2006)
Kovesi, P.: Image Features from Phase Congruency, Videre, 1999, MIT Press
Martin et al, Mammographic density measured with quantitative computer-aided method: comparison with radiologists' estimates and BI-RADS categories, Radiology, 240 (3), 2006, p 656
Martin, K. E., Helvie, M. A., Zhou, C., Roubidoux, M. A., Bailey, J. E., Paramagul, C., Blane, C. E., Klein, K. A., Sonnad, S. S., Chan, H. P.: Mammographic density measured with quantitative computer-aided method: comparison with radiologists' estimates and BI-RADS categories. Radiology. 240, 656-65 (2006)
McCormack, V., Highnam, R., Perry, N., dos Santos Silva, I: Comparison of a new and existing method of mammographic density measurement, Cancer, Epidemiol Biomarkers Prey 2007, 16(16), p 1148-54
Nicholson, B., LoRusso, A., Smolkin, M., Bovbjerg, V., Petroni, G., Harvey, J.: Accuracy of assigned BIRADS breast density category definitions, Academic Radiology, Volume 13, Issue 9, Page 1143-1149
Pawluczyk, O., Yaffe, M., Boyd, N., Jong, R.: Volumetric method for estimation of breast density on digitized screen-film mammograms, Medical Physics, 30(3), p 352, 2003
Pisano, E., Gatsonis, C., Yaffe, M., Hendrick, R., Tosteson, A., Fryback, D., Bassett, L., Baum, J., Conant, E., Jong, R., Rebner, M., D'Orsi, C.: American College of Radiology Imaging Network digital mammographic imaging screening trial: objectives and methodology. Radiology. 236, 404-12 (2005)
Prevrhal, S., Shepherd, J., Smith-Bindman, R., Cummings, S., Kerlikowske, K.: Accuracy of Mammographic Breast Density Analysis: Results of Formal Operator Training. Cancer Epidemiol Biomarkers Prey. 11, 1389-93 (2002)
Saftlas, A., Hoover, R., Brinton, L., Szlo, M., Olson, D., Salane, M., Wolfe, J. Mammographic densities and risk of breast cancer. Cancer 1991, 67: p 2833-2838
Saftlas, A., Szklo, M.: Mammographic parenchymal patterns and breast cancer risk. Epidemiol Rev 1987, 9: p 146-174
Shepherd, J.: Automated volumetric density, 3rd International Workshop on Breast Density, 2008
Tromans, C., Brady, M., Van de Sompel, D., Lorenzon, M., Bazzocchi, M., Zuiani, C.: Progress toward a quantitative scale for describing radiodensity in mammographic images, International Workshop on Digital Mammography 2008, Lecture Notes in Computer Science, 5116, Springer Berlin/Heidelberg
Vachon et al, Mammographic density, breast cancer risk and risk prediction: Breast Cancer Research, 2007, 9:217
van Engeland, S., Snoeren, P., Huisman, H., Boetes, C., Karssemeijer, N.: Volumetric breast density estimation from full-field digital mammograms, IEEE Medical Imaging, 25 (3), March 2006, p 273-282
Wolfe, J., Saftlas, A., Salane, M.: Mammographic parenchymal patterns and quantitative evaluation of mammographic densities: a case-control study. Am J Roentgenol 1987, 148: p 1087-1092
Wolfe, J.: Risk for breast cancer development determined by mammographic parenchymal patterns. Cancer, 1976, 37: p 2486-2492
Wolfe, J.: Breast patterns as an index of risk of developing breast cancer, Am J Roentgenol, 1976, 126: p 1130-9

What is claimed is:

1. A computer implemented method comprising:
inputting a digitized breast x-ray image of a subject into an electronic storage medium;
inputting the subject's medical history into the electronic storage medium,
analyzing the density of the breast x-ray image;
comparing the density of the image to the medical history of the subject; and
generating a numerical value.

2. The computer implemented method of claim 1, wherein the subject's medical history includes one or more of the following: 1) the subject has a breast cancer gene BRCA1; the subject has a breast cancer gene BRCA2; 2) the subject is a first degree relative (parent, sibling, or child) of someone with a breast cancer gene; 3) the subject has a lifetime breast cancer risk of 20-25% based on a breast cancer prediction model determined primarily by family history; 4) the subject has received radiation to the chest between age 10 and 30 years; and 4) the subject possesses one or more rare syndromes that have a high incidence of breast cancer.

3. The computer implemented method of claim 1, wherein analyzing the density of the breast x-ray image involves the use of a Volpara software program.

4. The computer implemented method of claim 1, wherein analyzing the density of the breast x-ray image involves the use of a Cumulus software program.

5. The computer implemented method of claim 1, wherein the numerical value is used to determine if the subject should have magnetic resonance imaging performed on breasts of the subject.

6. A device comprising:
a processor configured to:
extract a density measurement of a digitized breast x-ray image of a subject from an electronic storage medium;
extract a medical history of the subject from an electronic storage medium;
compare the density of the digitized x-ray image of the subject to the medical history of the subject; and
generate a value.

7. The device of claim 6, wherein the density measurement is extracted using Volpara software.

8. The device of claim 6, wherein the density measurement is extracted using Cumulus software.

9. The device of claim 6, wherein the extracted medical history includes one or more of the following: includes one or more of the following: 1) the subject has a breast cancer gene BRCA1; the subject has a breast cancer gene BRCA2; 2) the subject is a first degree relative (parent, sibling, or child) of someone with a breast cancer gene; 3) the subject has a lifetime breast cancer risk of 20-25% based on a breast cancer prediction model determined primarily by family history; 4) the subject has received radiation to the chest between age 10 and 30 years; and 4) the subject possesses one or more rare syndromes that have a high incidence of breast cancer.

10. The device of claim 6, wherein the value is a numerical value to determine whether the subject should have magnetic resonance imaging performed on breasts of the subject.
